(19) United States
(12) Patent Application Publication
(10) Pub. No.: US 2024/0301942 A1
(43) Pub. Date: Sep. 12, 2024

(54) SPRING LOADED SELF-TENSIONING IDLER ASSEMBLY FOR SERPENTINE PULLEY SYSTEM

(71) Applicant: Kenneth Lee Statton, Claremore, OK (US)

(72) Inventor: Kenneth Lee Statton, Claremore, OK (US)

(21) Appl. No.: 18/119,811

(22) Filed: Mar. 9, 2023

(51) Int. Cl. F16H 7/12

(52) U.S. Cl. CPC F16H 7/12; F16H 2007/081; F16H 2007/088

(57) ABSTRACT

An idler for small engines such as a Volkswagen that can mitigate the risk of human error when tightening a belt by incorporating a self-tensioning feature. This device utilizes spring resistance to enable a self-tensioning feature on this novel device. The spring loaded self-tensioning idler for small engines is mounted to an alternator or generator and comprises a mounting bracket, an idler bearing adjustable arm, a bearing collar, a wear sleeve, an idler bearing bolt, a sealed bearing, a stop pin, a torsion spring, acorn nuts, a shoulder bolt, a jam nut, and an internal snap ring.

### PRIORITY CLAIM TO PRIOR FILED APPLICATION

This application claims priority to prior filed Provisional Patent Application No. 63/318,006 filed on Mar. 9, 2022.

### BACKGROUND

### Field of Use

This device is a spring-loaded, constant tension idler assembly to be used in a small-sized engine, such as a smaller sized automobile. This type of device and its predecessors provide tension and guide the engine drive belt. These belts can wrap around the various parts of the engine such as the power steering pump, alternator, water pump and others. Idlers are complementary pulleys that make the entire system run smoothly.

### Background of Prior Art

Spring Loaded, self-tensioning idler assemblies have been commonplace on larger V6, V8 and larger engines for decades. They are successful because there is an enormous amount of surface travel on a larger engine belt compared to a smaller sized engine, such as a Volkswagon (VW) air-cooled engine. It is not uncommon for a larger engine belt to be as much as 70″ to 80″ in length, traveling over and around as many as 6 different pulley's and one or two idler setups. For example, the air-cooled VW serpentine belt is barely 20″ to 21″ in length, typically traveling over 2 pulleys and one idler. This shorter traveling distance can cause premature belt elongation and wear if the tension is set too tight. Too loose and you have the same issues or problems described when using the static tensioner setup. There are additional belt lengths for this application that can be used as well. We can incorporate add-ons such as air conditioning condensing units, power steering, pro-chargers and turbo setups to name a few. Once positioned, the spring-loaded idler can maintain constant application of tension and pressure through operational ranges of the engine with ease.

The standard Type 1 air-cooled small engine comes standard or as an original equipment manufacturer (OEM) item with a V-Belt setup. This V-Belt is tensioned using a two-piece upper pulley and a series of shims. The more shims between the pulleys, the shorter the belt becomes, and the opposite occurs with less shims between the pulleys. A product line has already been developed by inventor where the V-belt is no longer used, but instead a serpentine application has been employed.

There are two main problems with the static tension design: 1) the people variable, people frequently tend to over tighten the belt, and this can cause bearing and bracket failure; 2) static tensioning does not allow the bearing assembly to float with the belt when the engine is revved up, maintaining constant pressure between the bracket with the bearing stack up and the belt surface. This causes belt flop when jumping between high and low rpms and a squeak or squeal from the bearing surface as the belt jumps to and from contact. The spring-loaded or self-tensioning idler allows the bearing stack-up face, through the spring-loaded bracket assembly to remain in contact with the belt at all times.

The current technology is stationary. The original concept for the serpentine application on a small engine, such as a VW engine, was an attempt to make something different and sell it as a performance upgrade. The static tensioner was easy to make, mostly using scrap pieces of unneeded material and left-over items like air conditioning brackets and the like. Inventor was the first to make all the components of the assembly from billet materials and reduced cracking, fracturing and failures through consistent and precise machining of solid materials. The static tensioner, especially those on Inventor's Serpentine System continue to work today, but not without significant effort to keep people from damaging the product because of something they think they need to do, in place of what the manufacturer's instructions describe. Over-tightening is an issue that cannot be resolved without taking away the human requirement for application.

The Inventor has made many attempts at perfecting this design and it was not easy. It took Inventor several iterations of the internal bearing, spring and bolt assemblies to fine-tune machinability, maintenance, and manufacturing costs. Each step of the process yielded insight as to how this product could be made cost-effectively and still reach the desired level of performance necessary.

### DESCRIPTION

Disclosed herein is a novel static tensioner design utilizing a pair of billet machined bracket pieces that are bolted together and held in place with a unique face knurl design allowing for limited torque to hold in place while delivering maximum performance.

The original concept for the serpentine application on a small engine such as a VW engine was an attempt to make something different and sell it as a performance upgrade. Inventor was the first to make all of the components of the assembly from billet materials and reduced cracking, fracturing and failures through precise and consistent machining of solid materials. The static tensioner, especially those on Inventor's Serpentine System continue to work today, but not without significant effort to keep people from damaging the product because of something they think they need to do, in place of what the manufacturer's instructions describe. Over-tightening is an issue that cannot be resolved without taking away the human requirement for application.

The brackets support a bearing stack-up that track the belt, maintaining belt tension and delivering things like; reduced belt slip, more air flow, and increased horsepower, all while improving the look of your engine and delivering reliability the V-Belt system cannot match.

This design has evolved through several iterations over the years and been extremely reliable. There are two main problems with the static tension design that the new spring-loaded tensioner solves: 1) it removes the “people” variable. Even with clear and concise instructions, how-to videos, and constant communication, it is difficult to get people to stop over-tightening the belt. The general consensus among those in the art is that tighter is better. This is just not true as too much tension on the bearing portion of the idler causes bearing failure and bracket fracture or failure. 2) static tensioning does not allow the bearing assembly to float with the belt when the engine is revved up, maintaining constant pressure between the bracket with the bearing stack up and the belt surface. This causes belt flop when jumping between high and low revolutions per minute (rpm) and a squeak or squeal from the bearing surface as the belt jumps to and from contact. The spring-loaded or self-tensioning idler allows the bearing stack-up face, through the spring-loaded bracket assembly to remain in contact with the belt at all times. This removes the human error variable and the one place, static location of the tension arm allowing for unwanted flop at acceleration and bearing noises when engaging and disengaging from the surface of the belt. The self-tensioning spring-loaded idler also incorporates a stop pin positioned as to not allow the bracket to travel too far when the belt becomes aged, worn out or unsustainable for use. The operator/owner will be able to see when the belt is worn and ready for replacement.

The device is made from Billet aluminum, in place of cast alloy. The device is machined to precise tolerances, universal in its application, easy to install and fits nearly all possible combinations of small engine builds, particularly VWs. It is sleek, consistent, of high quality, affordable and available in a myriad of colors, cut out designs etc.

The spring-loaded tensioner setup is a direct replacement for the static setup and will even work with any of our competition in the serpentine pulley market where they also use a similar style of static tensioning. This spring-loaded design will replace static tensioner setups on inventor's serpentine kits on the market and in production as well as any serpentine style kit that has been manufactured dating back to the first aftermarket air-cooled serpentine pulley system design concepts in the 1960s. Inventor has removed the need for people to worry about belt tension as the unit maintains a constant tension. This design will run smoothly and allow the operator/owner to easily see when there is a need to replace a belt. The design reduces and/or removes bearing noise and removes bearing failure from over-tightening.

It is an object of the present invention to improve operational efficiency of a small engine, such as the VW air-cooled motor, while delivering a sleek, universal (useable on various VW serpentine system designs generated over the years) and improve our product offering. By adding the spring-loaded, self-tensioning design to the air-cooled VW engine, we can continue innovating and bringing large engine technology to the small engine application.

This design is novel to the small automobile air-cooled engine market. This design places all the operational functionality onto the product and removes the human interaction from the equation. The current technologies, while functional, do not allow for consistency in application. This device does.

This is a fully assembled, ready for installation assembly. When the customer receives the product, it is immediately ready to put into use. The kit comes complete with all mounting hardware and is fully assembled, tested and verified for accuracy. There are no optional parts or elements in this assembly. It is literally “plug and play”.

The spring-loaded idler assembly goes through the following steps for manufacturing and implementation: Main Mounting Bracket and Floating Idler Bracket are CNC machined from 6061-T6511 Extruded Aluminum Bar. Exact tolerances and finishes are shiny and polished straight from the machine. Floating Idler Arm is also machined from 6061-T6511 Extruded Aluminum Bar, same exacting tolerances for longevity and consistency. This item is also machined to mimic a polished finish and serves as the carrier for the bearing stack-up that keeps the belt tension constant. The internal torsion spring is custom designed for this application and carries the appropriate spring tension, wire diameter, temper, number of coils, etc. tested and required to maintain the proper amount of tension without under-engaging or over-engaging the belt and bearing combination without causing premature wear, fatigue or failure. The Idler Bearing bolt is custom made from 303 Stainless Steel to avoid corrosion. It is CNC machined and installed into the floating machined arm carrying the bearing stack up and collar. This stack up is held in place with a specific torque requirement as not to damage the bearings when installed and a jam nut on the back/opposite side, also torqued into place with specificity to avoid loosening in operation and bearing failure for over-tightening and creating lateral stress. There is a custom machined oil-impregnated plastic wear sleeve that is also CNC machined that serves as the wear/ride collar for the Idler Arm mounting to the Base/Mounting Bracket. This is a dissimilar material application to eliminate friction in operation and create a minimal expense replacement item should any wear occur over time. The center mounting bolt is CNC manufactured and threads into the center rotation point of the Idler Arm and is located using a thrust washer setup to assist in carrying the radial load when fully installed. There is a stop pin inserted into the back side of the arm and close to the jam nut for the bearing bolt installation. This stop pin restricts the downward travel of the arm keeping the bearing collar and stack up from touching the main crankshaft pulley and serving as an indicator for when the belt is work and in need of replacement. There are (3) custom CNC machined 8 mm Acorn nuts that affix the mounting bracket to the top of the Alternator or Generator Stand on the engine and utilizes the existing studs protruding from the case for installation ease. The Floating Idler Arm will be branded with the MST product logo (CNC Engraved). Each unit will be delivered to the customer pre-assembled and ready for installation. The Idler Arm will be resting on the stop pin after final assembly. When the customer receives it, along with installation instructions, they will affix to the motor, lift the arm using a wrench (standard item in their toolbox) and install the belt (sold separately).

This invention is designed and used specifically on air-cooled VW Type 1 engines. It is used in conjunction with the Inventor's Serpentine Pulley System (all variations) as well as other air-cooled engine serpentine kits previously made or currently made by competitors. The basic design can be modified by lengthening or shortening the Floating Idler Adjustment Arm to accommodate the various types of Air-Cooled VW Serpentine Pulley Systems. These may include the following setups and applications; Standard, Sand Seal, Center Mount, Center Mount Sand Seal, Standard and Center Mount Power Pulleys, Standard and Center Mount Dry Sump as well as an application to fit a Porsche Style Fan Shroud and center mount setup. These Idler Arms can also be modified to fit Air-cooled VW engines with air-conditioning, turbo chargers, power steering and pro-chargers as well as various other types of performance enhancing pulley improvements and applications.

This Spring-Loaded Self-Tensioning Assembly is designed for use on a VW air-cooled Type 1 engine setup. It replaces the static tensioner currently used by our company as well as all other similar static tensioner setups on the same type of engine application. The assembly bolts directly to the top of the base of the alternator/generator stand on the engine and uses the protruding studs and the custom machined acorn nuts provided with the kit to install. The alignment is close to automatic, but there is some built in lateral adjustment if needed through the slots (in place of holes) that rest over the studs. There is sufficient movement to allow for aligning the idler assembly to the pulleys without being so lose or free moving to cause installation issues. The main components are manufactured from base materials and are of aircraft grade and quality. Mounting Bracket, Idler Arm and Bearing Collar are CNC Machined from 6061-T6511 Aluminum Bar while the Idler Bearing Bolt is made from 303 Stainless Steel. The bearing collar is machined to allow for the (QTY 2) Bearings to lightly press fit into the center bore where they are held in place by a machined shoulder and followed with an internal snap ring and groove combination. The bearing collar is hard anodized to eliminate wear and is black in color to effectively accent the kit/assembly.

There is a Blue Plastic Oil-Impregnated wear sleeve CNC machined as well. This piece rests on machined diameter of the Idler Arm and Slides over the spring and into the Mounting Bracket Barrel. The wear sleeve is the dissimilar material keeping the aluminum from touching, eliminating friction and avoiding possible product failure.

The spring is custom designed for this specific application and is manufactured, heat treated and tested for accuracy.

There are several purchased items for this assembly: Bearings, Dowel Pin, Jam Nut, and a Snap Ring. These items are all corrosion resistant materials, standard items found at any long-standing hardware and fastener company and easily replicated if unavailable for purchase at any point in the future.

Assembly: The Wear Sleeve and Idler Arm are married together. Place the spring in barrel diameter of the Mounting Bracket and Slide the Idler Arm and Wear Sleeve together making sure to line the spring ends to the corresponding holes in both the Mounting Bracket and The Idler Arm. Install the Machined Shoulder Bolt through the back of the Mounting Bracket upright and snug the two together (Use Thread Locker). There is a specific torques specification to follow here. There is now spring tension on the bracket and arm. Lift the arm using a custom installation fixture and insert the Stop Pin. Rest the Stop Pin on the Mounting Bracket. Next, install two bearings and snap ring into bearing collar. Slide Bearings over 303 Stainless Steel Idler Bearing Bolt and thread into Idler Arm location at end. Tighten using torque spec. Apply Thread Locker to jam nut and install. Torque to specification. Assembly is complete.

Idler Assembly, Acorn Nuts, Installation Instructions (either individual for this assembly or all-inclusive for full Serpentine Kit) are added. Kit is ready to ship and install.

Installation: After all steps involved in installing pulleys are performed, remove the 3 required nuts holding Alternator/Generator Stand in place. Place Aluminum Mounting Bracket over studs, add acorn nuts and snug for pre-alignment. Install belt. Lift Arm, add belt to location on bearing collar face and release arm to touch belt. Adjust bracket to base as needed to align bearing collar, bracket and pulleys for straight line operation. Tighten mounting bracket to base. Install is complete. Idler is tensioned appropriately to belt and bearing and ready for operation.

The Spring-Loaded Idler is now ready for use with Serpentine System. You will see instant results related to constant tension, even while revving the motor and at idle where these is only smooth operation and little or no belt slip. The requirement for a person to apply belt tension is gone and the unit will run quietly and efficiently for many miles without the need for human interference. When the belt is worn passed its useful life, the owner/operator will be able to clearly see that the tensioner has reached its stop or endpoint signaling the need for a new belt. Then, all you must do is lift the arm, remove the old belt, add the new one and release the arm back into its resting position against the belt.

This application is designed to provide hours and hours of operation and use without the worry of losing a belt, locking up a bearing, breaking a bracket or creating other issues because the previous unit was unable to accommodate the automation provided by the Spring-Loaded, Self-Tensioning Idler Assembly for the VW air-cooled Serpentine System.

Although the invention has been described in detail with reference to several embodiments additional variations and modifications exist within the scope of the spirit of the invention as described.

Although the disclosed invention has been described with reference to various exemplary embodiments, it is to be understood that these embodiments are merely illustrative of the principals and application of the present invention. Those having skill in the art would recognize that various modifications to the exemplary embodiments may be made, without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from considerations of the specification and practice of the invention disclosed herein. It is intended that the specification and examples be considered as exemplary only, with a scope and spirit being indicated by the claims.

Finally, it is noted that, as used in this specification and the appended claims, the singular forms “a”, “an”, and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

### DESCRIPTION OF THE DRAWINGS

The following reference numbers correspond to the drawings:
10 Assembled spring loaded idler
11 Idler Mount
12 Wear sleeve
13 Idler bearing adjustable arm
14 Idler bearing bolt
15 Sealed bearing
16 Alternator or generator stand (not part of novel device)
17 Bearing collar
18 Stop pin
19 Torsion spring
20 Custom acorn nut
21 Shoulder bolt
22 Jam nut
23 Internal snap ring

FIG. 1 shows a perspective view of the idler bearing adjustable arm 13 portion of the device.

FIG. 2 shows a rear view of the idler bearing adjustable arm 13 portion of the device.

FIG. 3 shows a frontal view of the idler bearing adjustable arm 13 portion of the device.

FIG. 4 shows a side view of the idler bearing adjustable arm 13 portion of the device.

FIG. 5 shows an upper view of the idler bearing adjustable arm 13 portion of the device.

FIG. 6 shows a perspective view of the idler mount 11 portion of the device.

FIG. 7 shows a rear view of the idler mount 11 portion of the device.

FIG. 8 shows a side view of the idler mount 11 portion of the device.

FIG. 9 shows a top view of the idler mount 11 portion of the device.

FIG. 10 shows a perspective view of the plastic wear sleeve 12 portion of the device,

FIG. 11 shows a rear view of the plastic wear sleeve 12 portion of the device.

FIG. 12 shows a side view of the plastic wear sleeve 12 portion of the device.

FIG. 13 shows a perspective view of the idler bearing bolt 14 portion of the device.

FIG. 14 shows a rear view of the idler bearing bolt 14 portion of the device.

FIG. 15 shows a side view of the idler bearing bolt 14 portion of the device.

FIG. 16 shows a perspective view of the bearing collar 17 portion of the device.

FIG. 17 shows a side view of the bearing collar 17 portion of the device.

FIG. 18 shows a perspective view of the custom acorn nut 20 portion of the device.

FIG. 19 shows a rear view of the custom acorn nut 20 portion of the device.

FIG. 20 shows a side view of the custom acorn nut 20 portion of the device.

FIG. 21 shows a perspective view of the torsion spring 19 portion of the device.

FIG. 22 shows a side view of the torsion spring 19 portion of the device.

FIG. 23 shows a frontal view of the torsion spring 19 portion of the device.

FIG. 24 shows a rear view of the torsion spring 19 portion of the device.

FIG. 25 shows a frontal perspective view of the device 10 the spring-loaded idler featuring idler mount 11, acorn nuts 20, idler bearing adjustable arm 13, bearing collar 17, and idler bearing bolt 14.

FIG. 26 shows a rear perspective view of the device 10 the spring-loaded idler featuring acorn nuts 20, shoulder bolt 21, idler mount 11, stop pin 18, jam nut 24, and bearing collar 17.

FIG. 27 shows a rear side view of the idler bearing adjustable arm 13, bearing collar 17, stop pin 18, internal torsion spring 19, shoulder bolt 21, and jam nut 22.

FIG. 28 shows a front view of the device the spring-loaded idler featuring idler mount 11, bearing collar 17, idler bearing bolt 14, acorn nut 20, and idler bearing adjuster 13.

FIG. 29 shows a rear view of the device featuring idler mount 11, bearing collar 17, and shoulder bolt 21.

FIG. 30 shows a frontal view of the device featuring idler mount 11, bearing collar 17, open view of the idler bearing adjuster featuring the shoulder bolt 21 and internal torsion spring 19.

FIG. 31 shows a frontal perspective view of the device mounted 11 to a generator or stand alternator also featuring bearing collar 17, and idler bearing adjustable arm 13.

FIG. 32 shows a rear side view of the device 10 the spring-loaded idler mounted to an generator or stand alternator featuring shoulder bolt 21, acorn nut 20, idler mount 11, and bearing collar 17.

FIG. 33 shows an exploded view of the device 10 featuring shoulder bolt 21, acorn nuts 20, stop pin 18, jam nut 22, idler mount 11, internal torsion spring 19, bearing collar 17, idler bearing adjustable arm 13, wear sleeve 12, sealed bearing 15, internal snap ring 23, and idler bearing bolt 14.

FIG. 34 shows a perspective view of the shoulder bolt 21.

FIG. 35 shows a frontal view of the shoulder bolt 21.

FIG. 36 shows a side view of shoulder bolt 21.

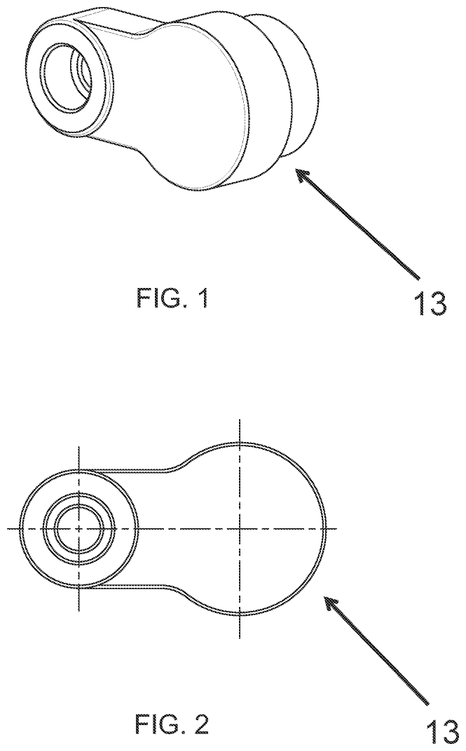

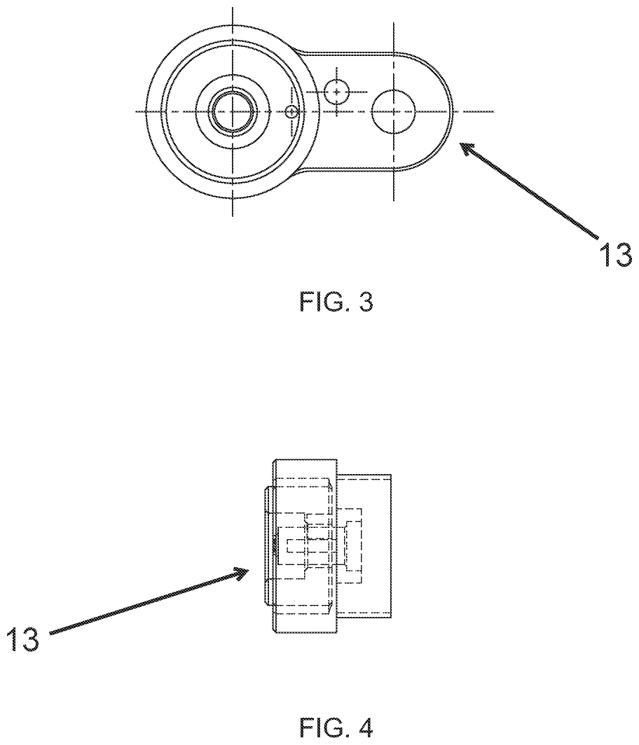

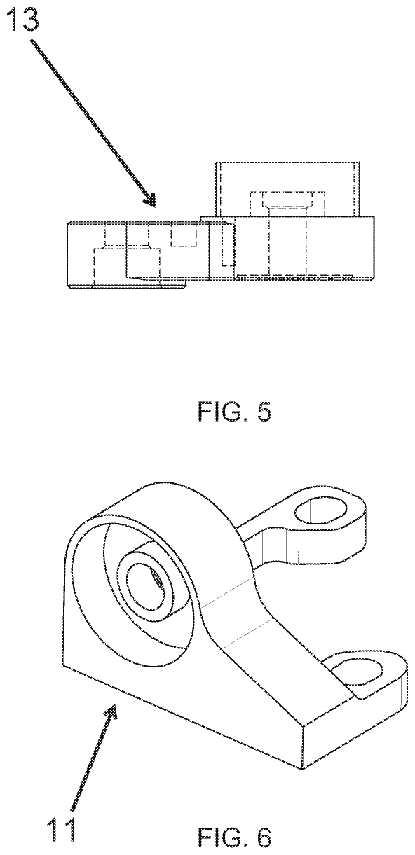

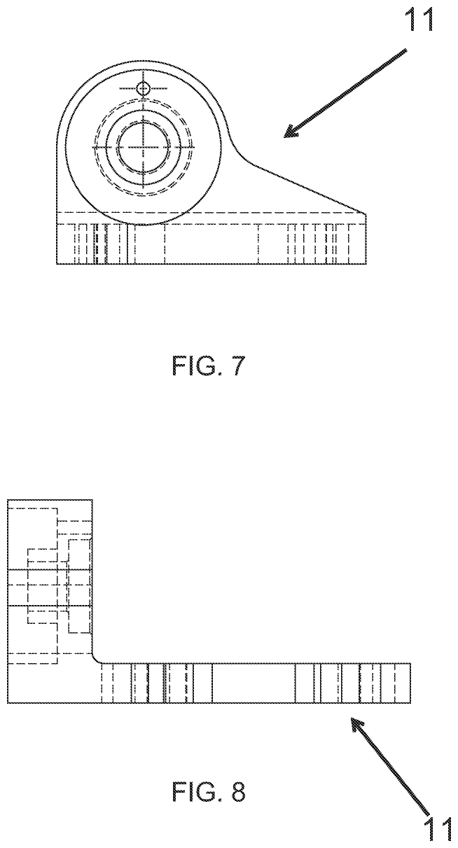

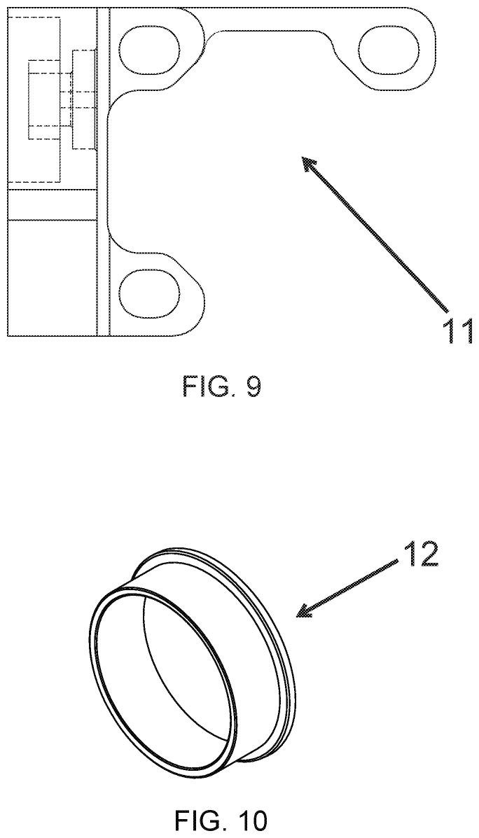

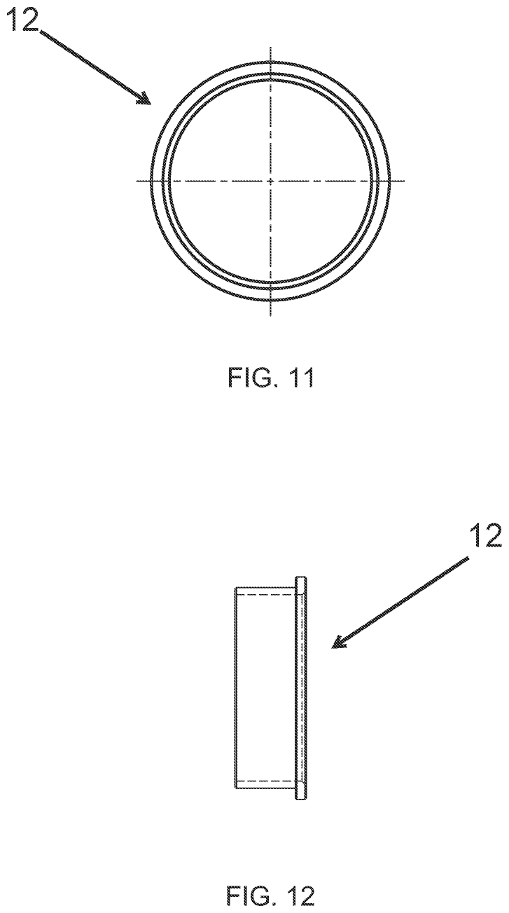

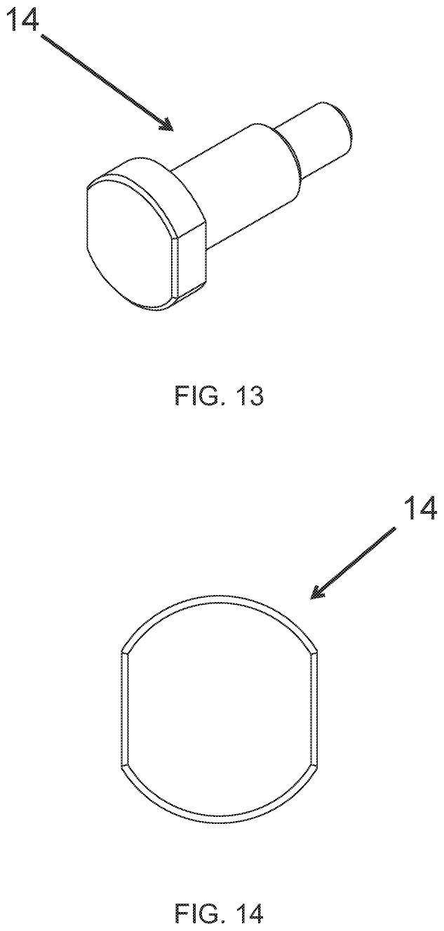

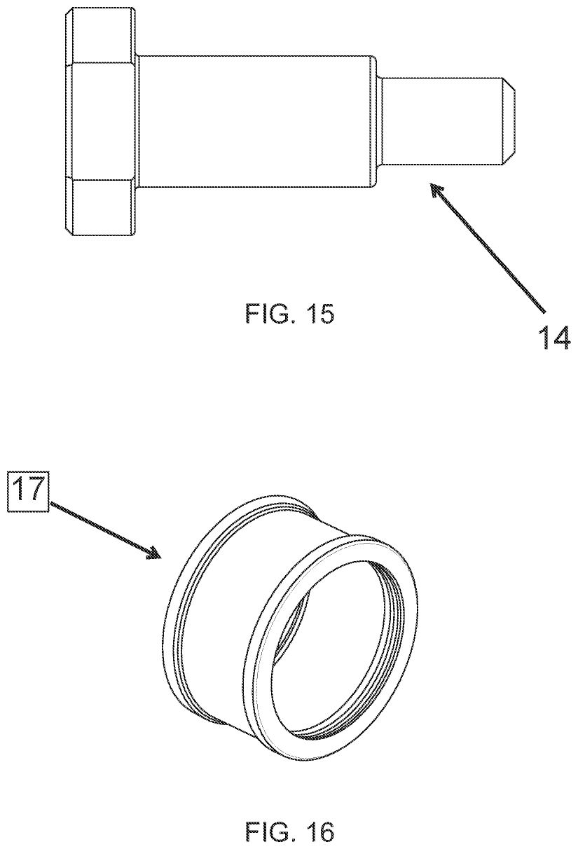

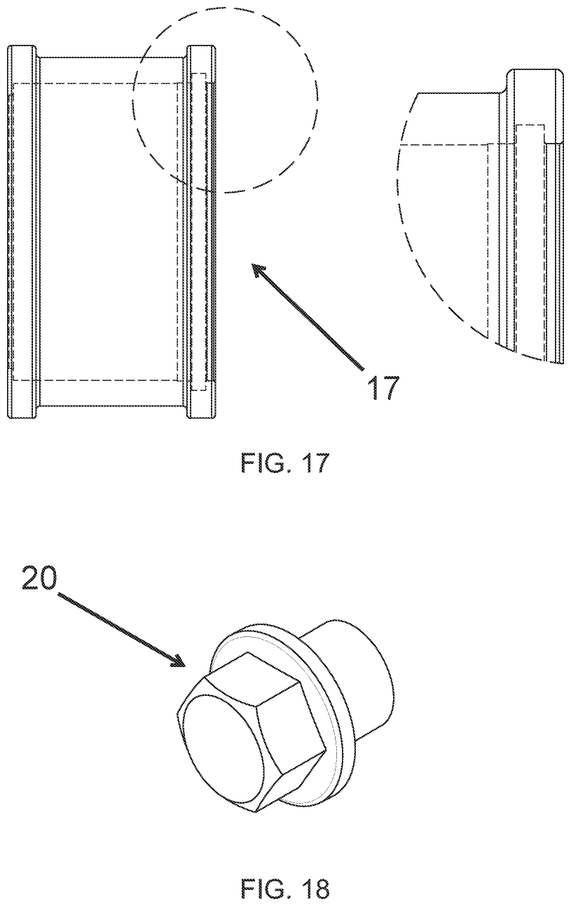

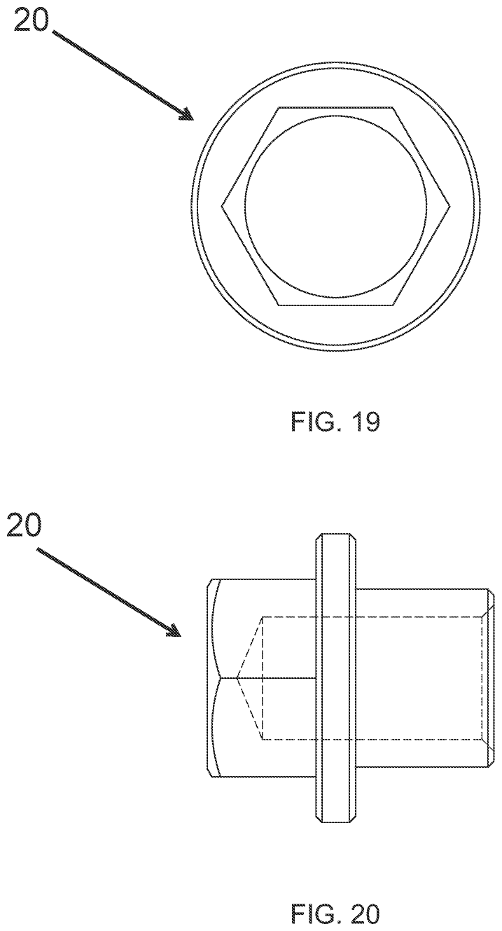

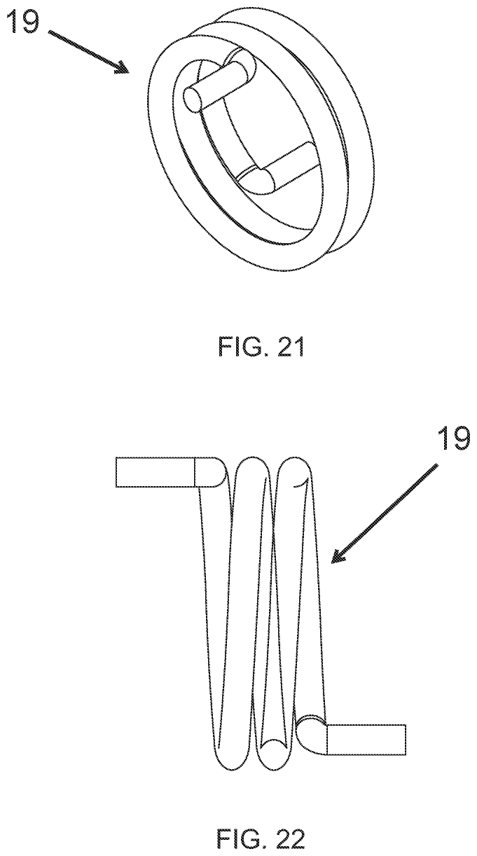

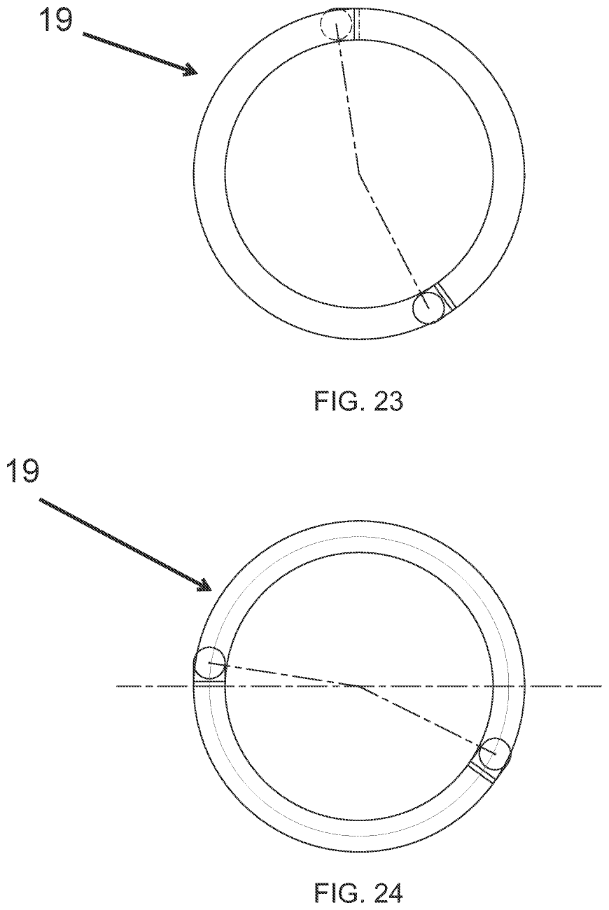

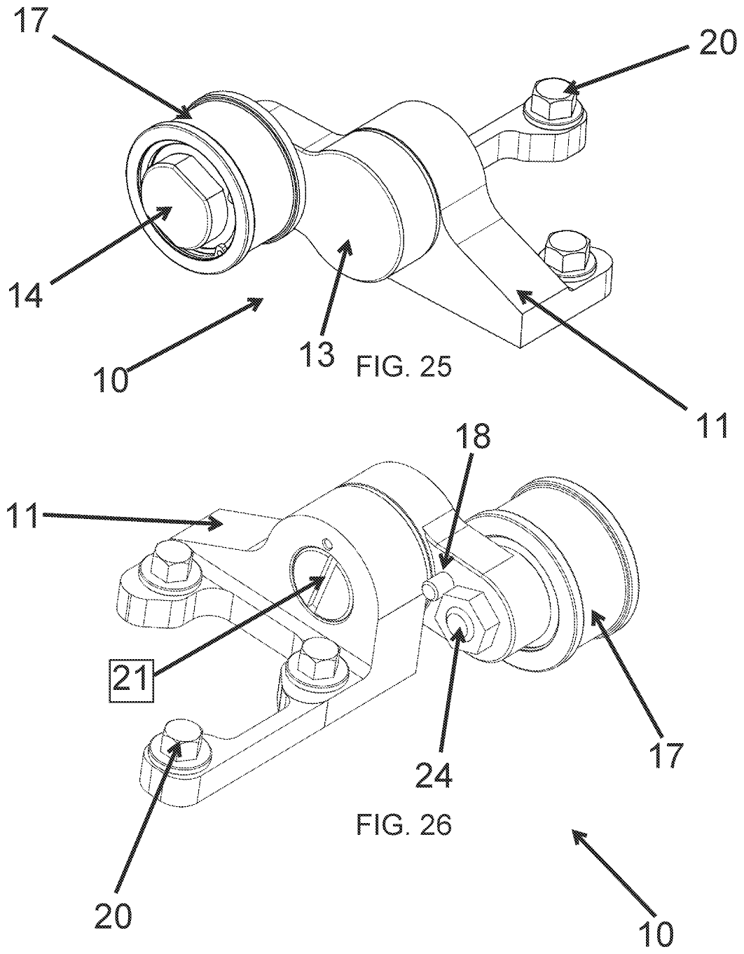

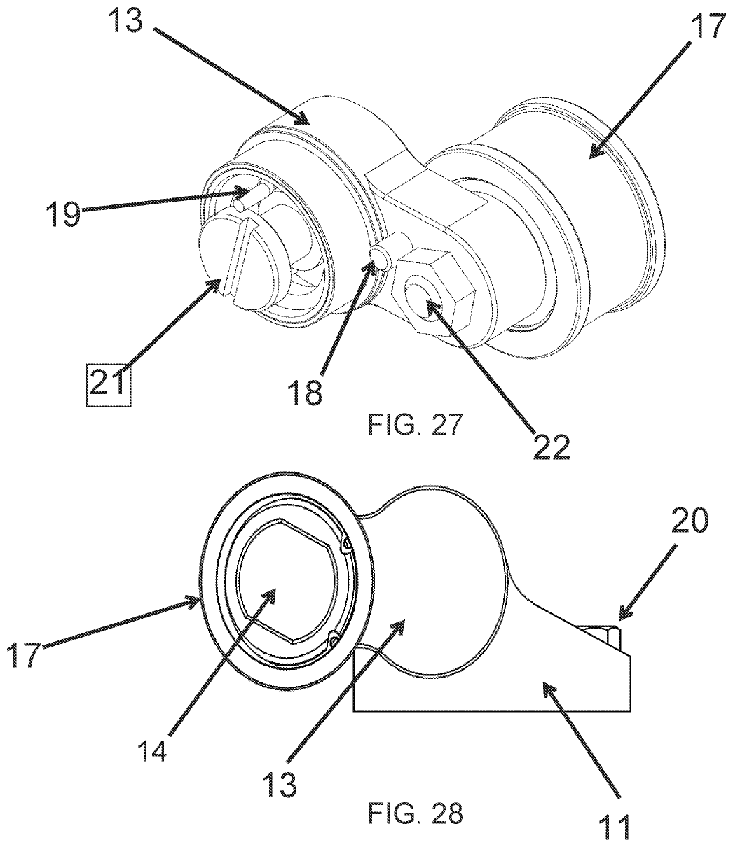

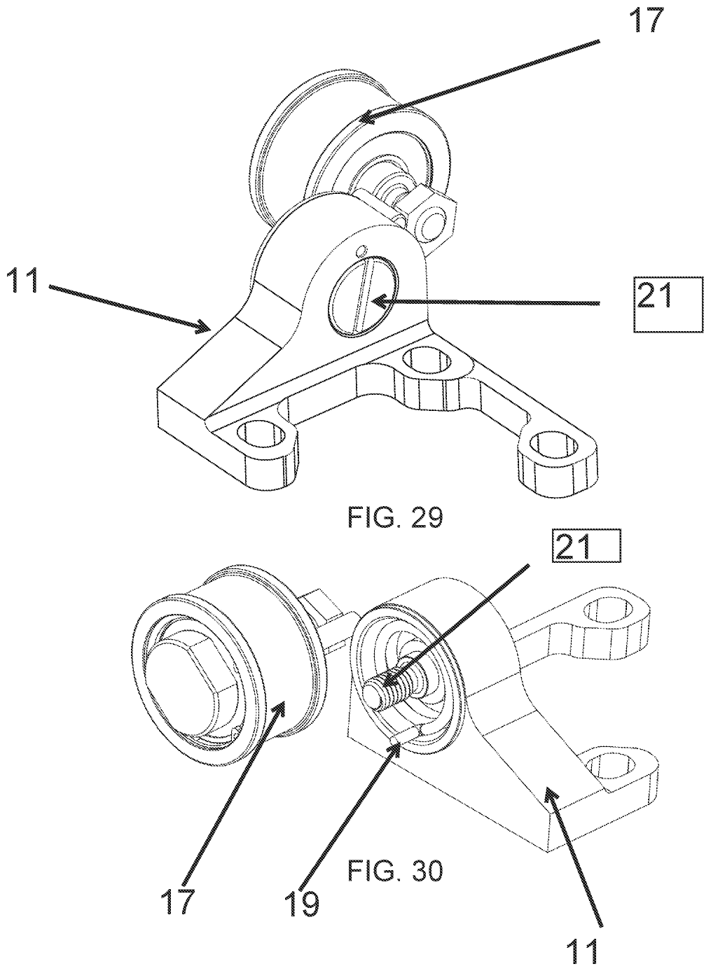

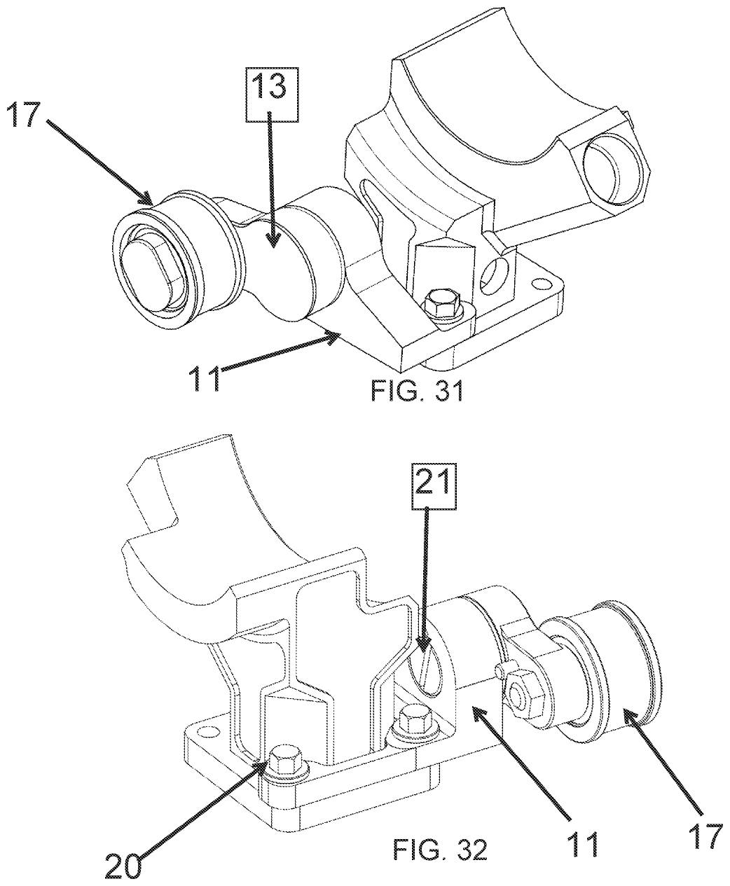

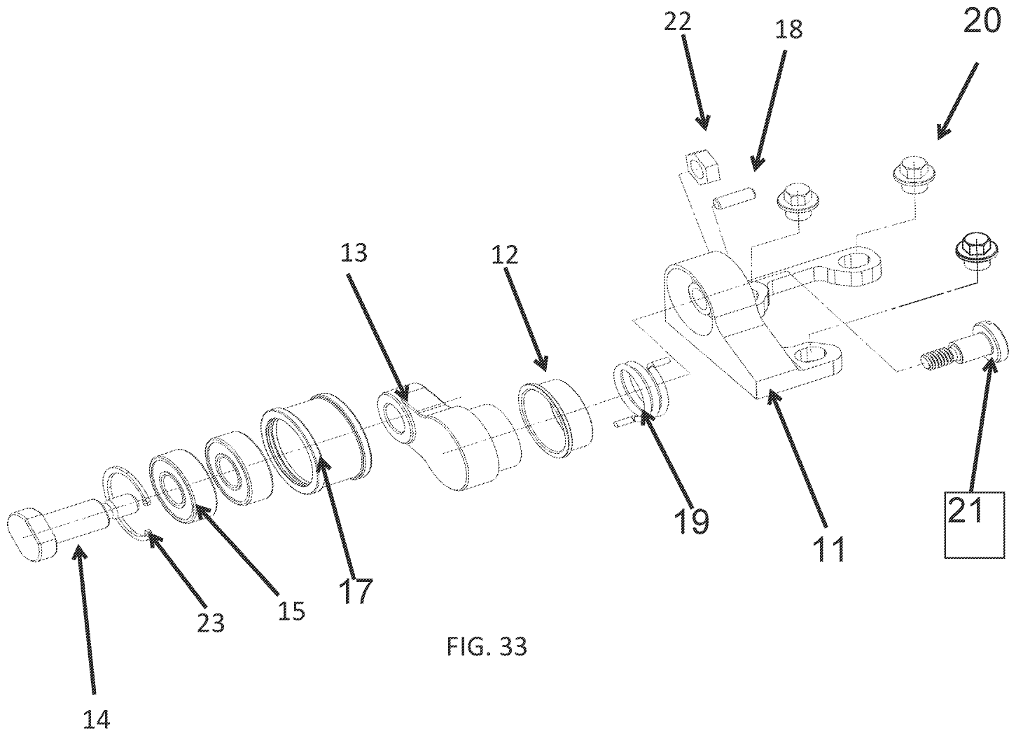

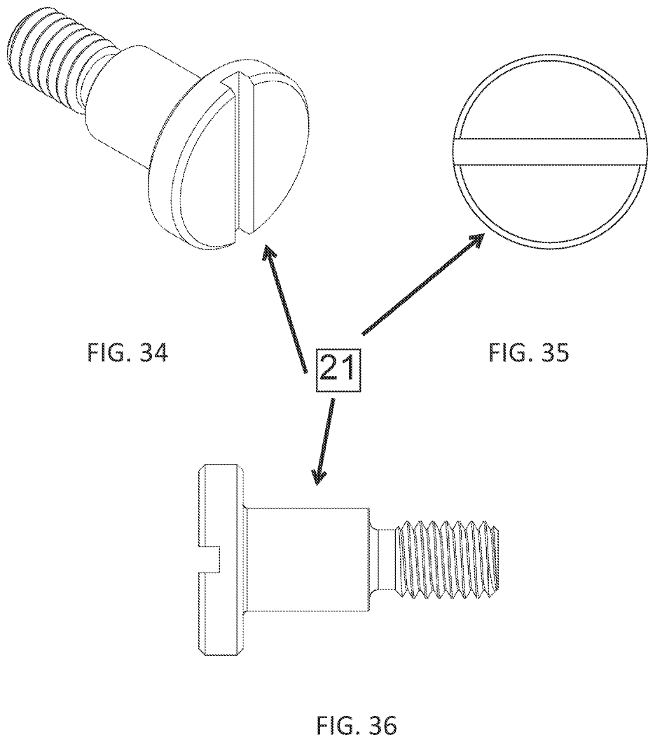

What is claimed is:

1. A spring loaded self-tensioning idler assembly for a small automobile engine comprising:
an at least one mounting bracket,
an at least one idler bearing adjustable arm, and
an at least one bearing collar.

2. The device of claim 1 wherein said at least one mounting bracket has a main engine body facing side and an idler bearing adjustable arm facing side.

3. The device of claim 1 wherein said at least one mounting bracket has an at least two or more points of attachment on said main engine body facing side to secure said at least one mounting bracket to said small automobile engine.

4. The device of claim 1 wherein said at least one mounting bracket is secured to said small automobile engine on said main engine body facing side by an at least two or more bolts.

5. The device of claim 1 wherein said at least one idler bearing adjustable arm further comprises an at least one internal torsion spring and an at least one wear sleeve wherein said an at least one internal torsion spring is the element which enables said self-tensioning feature.

6. The device of claim 1 wherein said at least one idler bearing adjustment arm comprises a mounting bracket facing side and an away facing side.

7. The device of claim 1 wherein said at least one mounting bracket further comprises an opening through which an at least one shoulder bolt secures said at least one idler bearing adjustable arm to said at least one mounting bracket on said idler bearing adjustable arm facing side.

8. The device of claim 1 wherein said at least one idler bearing adjustable arm further comprises an at least one stop pin and an at least one jam nut on said mounting bracket facing side.

9. The device of claim 1 wherein said at least one idler bearing collar further comprises an at least one idler bearing bolt, an at least one internal snap ring, and an at least one sealed bearing.

10. The device of claim 1 wherein said at least one idler bearing collar is affixed to said at least one idler bearing adjustable arm by said at least one idler bearing bolt, said at least one internal snap ring, and said at least one sealed bearing on said away facing side.
